(19) United States
(12) Patent Application Publication
(10) Pub. No.: US 2026/0342848 A1
(43) Pub. Date: Oct. 29, 2026

(54) QUANTUM RANDOM NUMBER GENERATOR PROVENANCE AND SECURITY ANALYSIS

(71) Applicant: Cisco Technology, Inc., San Jose, CA (US)

(72) Inventors: Ashish Kundu, Milpitas, CA (US); Ramana Rao V.R. Kompella, Foster City, CA (US); Eneet Kaur, Somerville, MA (US); Jiapeng Zhao, Kenmore, WA (US)

(73) Assignee: Cisco Technology, Inc., San Jose, CA (US)

(21) Appl. No.: 19/095,676

(22) Filed: Mar. 31, 2025

(51) Int. Cl. H04L 9/40; G06N 10/80; H04L 9/08

(52) U.S. Cl. CPC H04L 63/1491; G06N 10/80; H04L 9/0852

(57) ABSTRACT

In one implementation, a device may determine that an operations supply chain for a quantum noise source is a compromised supply chain. The device may discontinue generation of a quantum random number utilizing the compromised supply chain. The device may initiate sourcing of trusted quantum noise from a trusted quantum noise source. The device may cause the trusted quantum noise to be utilized in the generation of a quantum random number.

### TECHNICAL FIELD

The present disclosure relates generally to wireless communications and, more particularly, to quantum random number generator provenance and security analysis.

### BACKGROUND

Today, random number generation is at the core of many computing systems ranging from security to gaming, among others. For instance, in the case of cryptography, the degree of randomness (i.e., entropy) underlying a cryptographic key can dictate how difficult it would be for a malicious entity to guess that key. However, random number generators (RNGs) today also do not rely on true randomness, but instead leverage pseudo-random number generation algorithms that seek to generate numbers that mimic the properties of truly random numbers.

Recently, there has been increased interest in quantum systems and their use in quantum RNGs (QRNGs), as the physical properties of quantum systems exhibit true randomness. Using such a quantum system as a source of entropy could lead to a truly random number generator. In turn, using truly random numbers can increase the security of a system, as there is always the possibility of the pseudo-random algorithm being subverted or compromised.

Even with a source of quantum entropy, though, the trustworthiness of its resulting random numbers is still a function of the trustworthiness of its supply chain. For instance, if the pipeline that supplies the quantum entropy to the QRNG becomes compromised, the resulting random numbers will also be compromised.

### BRIEF DESCRIPTION OF THE DRAWINGS

The implementations herein may be better understood by referring to the following description in conjunction with the accompanying drawings in which like reference numerals indicate identically or functionally similar elements, of which:

FIGS. 1A-1B illustrate an example communication network;

FIG. 2 illustrates an example computing device/node;

FIG. 3 illustrates an example wireless network;

FIG. 4 illustrates an example architecture for quantum random number generator provenance and security analysis;

FIG. 5 illustrates an example architecture utilizing a honeypot strategy to mitigate compromised QRNG pipelines; and

FIG. 6 illustrates an example simplified procedure for quantum random number generator provenance and security analysis, in accordance with one or more implementations described herein.

### DESCRIPTION OF EXAMPLE IMPLEMENTATIONS

### Overview

According to one or more implementations of the disclosure, a device may determine that an operations supply chain for a quantum noise source is a compromised supply chain. The device may discontinue generation of a quantum random number utilizing the compromised supply chain. The device may initiate sourcing of trusted quantum noise from a trusted quantum noise source. The device may cause the trusted quantum noise to be utilized in the generation of a quantum random number.

Other implementations are described below, and this overview is not meant to limit the scope of the present disclosure.

### Description

A computer network is a geographically distributed collection of nodes interconnected by communication links and segments for transporting data between end nodes, such as personal computers and workstations, or other devices, such as sensors, etc. Many types of networks are available, with the types ranging from local area networks (LANs) to wide area networks (WANs). LANs typically connect the nodes over dedicated private communications links located in the same general physical location, such as a building or campus. WANs, on the other hand, typically connect geographically dispersed nodes over long-distance communications links, such as common carrier telephone lines, optical lightpaths, synchronous optical networks (SONET), or synchronous digital hierarchy (SDH) links, or Powerline Communications (PLC) such as IEEE 61334, IEEE P 1901.2, and others. The Internet is an example of a WAN that connects disparate networks throughout the world, providing global communication between nodes on various networks. The nodes typically communicate over the network by exchanging discrete frames or packets of data according to predefined protocols, such as the Transmission Control Protocol/Internet Protocol (TCP/IP). In this context, a protocol consists of a set of rules defining how the nodes interact with each other. Computer networks may be further interconnected by an intermediate network node, such as a router, to extend the effective “size” of each network.

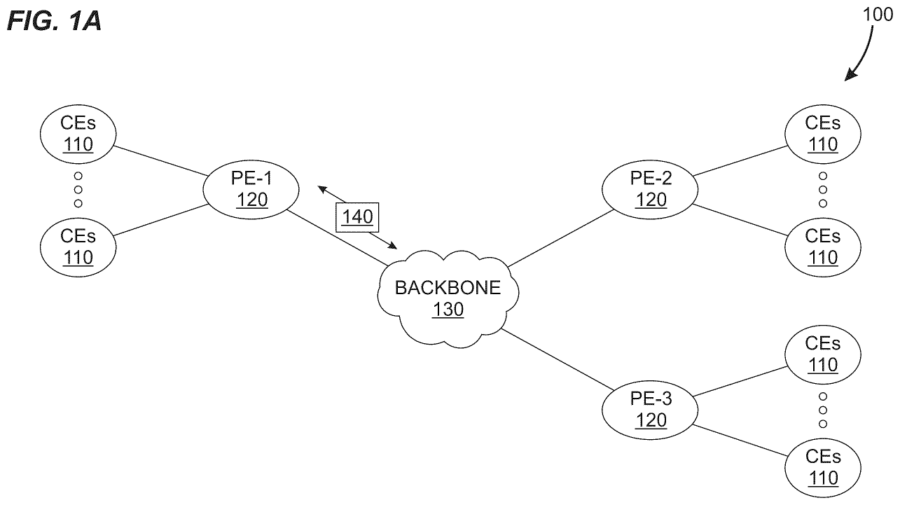

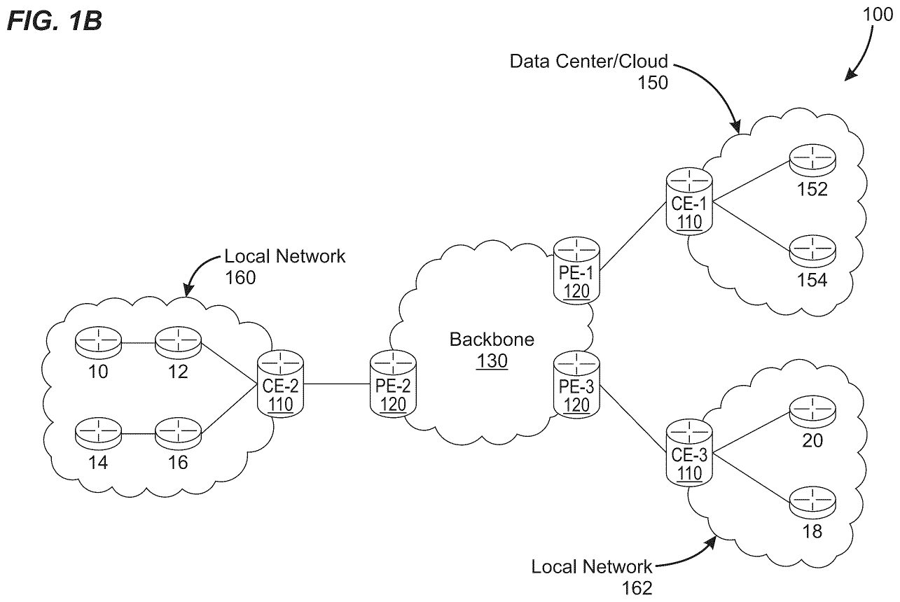

FIG. 1A is a schematic block diagram of an example network 100 illustratively comprising nodes/devices, such as a plurality of routers/devices interconnected by links or networks, as shown. For example, customer edge (CE) routers (e.g., routers 110) may be interconnected with provider edge (PE) routers 120 (e.g., PE-1, PE-2, and PE-3) in order to communicate across a core network, such as network backbone 130. For example, routers 110, 120 may be interconnected by the public Internet, a multiprotocol label switching (MPLS) virtual private network (VPN), or the like. Data packets 140 (e.g., traffic/messages) may be exchanged among the nodes/devices of the network 100 over links using predefined network communication protocols such as the Transmission Control Protocol/Internet Protocol (TCP/IP), User Datagram Protocol (UDP), Asynchronous Transfer Mode (ATM) protocol, Frame Relay protocol, or any other suitable protocol. Those skilled in the art will understand that any number of nodes, devices, links, etc. may be used in the computer network, and that the view shown herein is for simplicity.

In some implementations, a router or a set of routers may be connected to a private network (e.g., dedicated leased lines, an optical network, etc.) or a virtual private network (VPN), such as an MPLS VPN thanks to a carrier network, via one or more links exhibiting very different network and service level agreement characteristics. For the sake of illustration, a given customer site may fall under any of the following categories:
1.) Site Type A: a site connected to the network (e.g., via a private or VPN link) using a single CE router and a single link, with potentially a backup link (e.g., a 3G/4G/5G/LTE backup connection). For example, a particular CE router (e.g., of the routers 110) shown in network 100 may support a given customer site, potentially also with a backup link, such as a wireless connection.
2.) Site Type B: a site connected to the network by the CE router via two primary links (e.g., from different Service Providers), with potentially a backup link (e.g., a 3G/4G/5G/LTE connection). A site of type B may itself be of different types:
2a.) Site Type B1: a site connected to the network using two MPLS VPN links (e.g., from different Service Providers), with potentially a backup link (e.g., a 3G/4G/5G/LTE connection).
2b.) Site Type B2: a site connected to the network using one MPLS VPN link and one link connected to the public Internet, with potentially a backup link (e.g., a 3G/4G/5G/LTE connection). For example, a particular customer site may be connected to network 100 via PE-3 and via a separate Internet connection, potentially also with a wireless backup link.
2c.) Site Type B3: a site connected to the network using two links connected to the public Internet, with potentially a backup link (e.g., a 3G/4G/5G/LTE connection).

Notably, MPLS VPN links are usually tied to a committed service level agreement, whereas Internet links may either have no service level agreement at all or a loose service level agreement (e.g., a “Gold Package” Internet service connection that guarantees a certain level of performance to a customer site).
3.) Site Type C: a site of type B (e.g., types B 1, B2 or B3) but with more than one CE router (e.g., a first CE router connected to one link while a second CE router is connected to the other link), and potentially a backup link (e.g., a wireless 3G/4G/5G/LTE backup link). For example, a particular customer site may include a first CE router (e.g., of the routers 110) connected to PE-2 and a second CE router (e.g., of the routers 110) connected to PE-3.

FIG. 1B illustrates an example of network 100 in greater detail, according to various implementations. As shown, network backbone 130 may provide connectivity between devices located in different geographical areas and/or different types of local networks. For example, network 100 may comprise local networks/branch networks (e.g., local network 160, local network 162, etc.) that include devices/nodes 10-16 and devices/nodes 18-20, respectively, as well as a data center/cloud environment 150 that includes servers 152-154. Notably, local networks 160-162 and data center/cloud environment 150 may be located in different geographic locations.

Servers 152-154 may include, in various implementations, a network management server (NMS), a dynamic host configuration protocol (DHCP) server, a constrained application protocol (CoAP) server, an outage management system (OMS), an application policy infrastructure controller (APIC), an application server, etc. As would be appreciated, network 100 may include any number of local networks, data centers, cloud environments, devices/nodes, servers, etc.

In some implementations, the techniques herein may be applied to other network topologies and configurations. For example, the techniques herein may be applied to peering points with high-speed links, data centers, etc.

According to various implementations, a software-defined WAN (SD-WAN) may be used in network 100 to connect local network 160, local network 162, and data center/cloud environment 150. In general, an SD-WAN uses a software defined networking (SDN)-based approach to instantiate tunnels on top of the physical network and control routing decisions, accordingly. For example, as noted above, one tunnel may connect router CE-2 at the edge of local network 160 to router CE-1 at the edge of data center/cloud environment 150 over an MPLS or Internet-based service provider network in network backbone 130. Similarly, a second tunnel may also connect these routers over a 4G/5G/LTE cellular service provider network. SD-WAN techniques allow the WAN functions to be virtualized, essentially forming a virtual connection between local network 160 and data center/cloud environment 150 on top of the various underlying connections. Another feature of SD-WAN is centralized management by a supervisory service that can monitor and adjust the various connections, as needed.

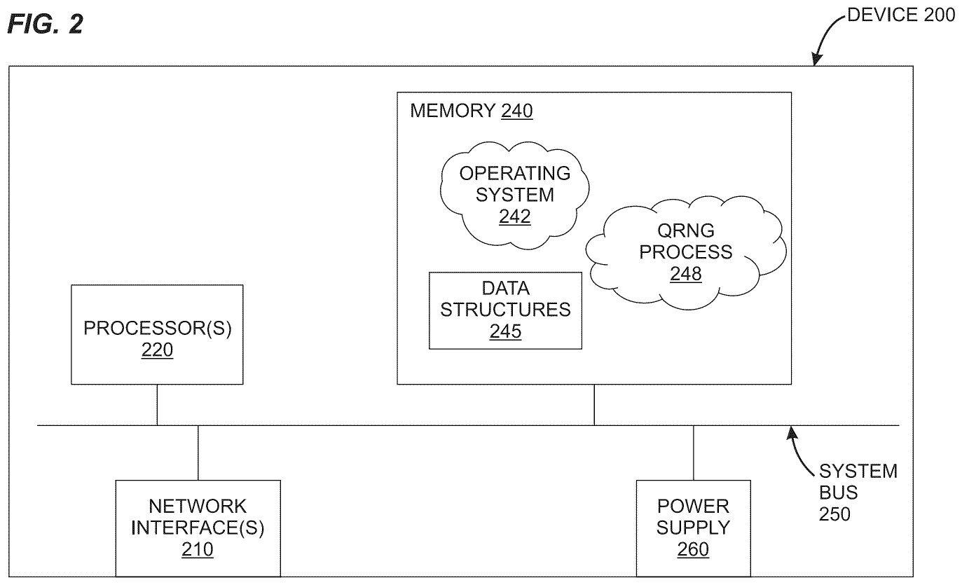

FIG. 2 is a schematic block diagram of an example node/device 200 (e.g., an apparatus) that may be used with one or more implementations described herein, e.g., as any of the devices shown in FIGS. 1A-1B above. Device 200 may comprise one or more network interfaces, such as interfaces 210 (e.g., wired, wireless, network interfaces, etc.), at least one processor (e.g., processor 220), and a memory 240 interconnected by a system bus 250, as well as a power supply 260 (e.g., battery, plug-in, etc.).

The interfaces 210 contain the mechanical, electrical, and signaling circuitry for communicating data over links coupled to the network(s), such as network 100. The network interfaces may be configured to transmit and/or receive data using a variety of different communication protocols. Note, further, that device 200 may have multiple types of network connections via interfaces 210, e.g., wireless and wired/physical connections, and that the view herein is merely for illustration.

Depending on the type of device, other interfaces, such as input/output (I/O) interfaces 230, user interfaces (UIs), and so on, may also be present on the device. Input devices, in particular, may include an alpha-numeric keypad (e.g., a keyboard) for inputting alpha-numeric and other information, a pointing device (e.g., a mouse, a trackball, stylus, or cursor direction keys), a touchscreen, a microphone, a camera, and so on. Additionally, output devices may include speakers, printers, particular network interfaces, monitors, etc.

The memory 240 comprises a plurality of storage locations that are addressable by the processor 220 and the interfaces 210 for storing software programs and data structures associated with the implementations described herein. The processor 220 may comprise hardware elements or hardware logic adapted to execute the software programs and manipulate the data structures 245. An operating system 242, portions of which are typically resident in memory 240 and executed by the processor, functionally organizes the device by, among other things, invoking operations in support of software processes and/or services executing on the device. These software processes and/or services may comprise a QRNG security process 248, as described herein.

It will be apparent to those skilled in the art that other processor and memory types, including various computer-readable media, may be used to store and execute program instructions pertaining to the techniques described herein. Also, while the description illustrates various processes, it is expressly contemplated that various processes may be implemented as modules configured to operate in accordance with the techniques herein (e.g., according to the functionality of a similar process). Further, while processes may be shown and/or described separately, those skilled in the art will appreciate that processes may be routines or modules within other processes.

In various implementations, as detailed further below, QRNG security process 248 may include computer executable instructions that, when executed by processor 220, cause device 200 to perform the techniques described herein. To do so, in some implementations, QRNG security process 248 may utilize artificial intelligence (AI)/machine learning (ML). In general, AI/ML is concerned with the design and the development of techniques that take as input empirical data (such as network statistics and performance indicators) and recognize complex patterns in these data. One very common pattern among these techniques is the use of an underlying model M, whose parameters are optimized for minimizing the cost function associated to M, given the input data. For instance, in the context of classification, the model M may be a straight line that separates the data into two classes (e.g., labels) such that M=a*x+b*y+c and the cost function would be the number of misclassified points. The learning process then operates by adjusting the parameters a, b, c such that the number of misclassified points is minimal. After this optimization phase (or learning phase), the model M can be used very easily to classify new data points. Often, M is a statistical model, and the cost function is inversely proportional to the likelihood of M, given the input data.

In various implementations, QRNG security process 248 may leverage one or more supervised, unsupervised, or semi-supervised AI/ML models. Generally, supervised learning entails the use of a training set of data that is used to train the model to apply labels to the input data. For example, the training data may include sample configurations labeled with textual metadata. On the other end of the spectrum are unsupervised techniques that do not require a training set of labels. Notably, while a supervised learning model may look for previously seen patterns that have been labeled as such, an unsupervised model may instead look to whether there are sudden changes or patterns in the behavior of the metrics. Semi-supervised learning models take a middle ground approach that uses a greatly reduced set of labeled training data.

Example AI/ML techniques that the QRNG security process 248 may employ include, but are not limited to, nearest neighbor (NN) techniques (e.g., k-NN models, replicator NN models, etc.), statistical techniques (e.g., Bayesian networks, etc.), clustering techniques (e.g., k-means, mean-shift, etc.), neural networks (e.g., reservoir networks, artificial neural networks, etc.), support vector machines (SVMs), long short-term memory (LSTM), logistic or other regression, Markov models or chains, principal component analysis (PCA) (e.g., for linear models), singular value decomposition (SVD), multi-layer perceptron (MLP) artificial neural networks (ANNs) (e.g., for non-linear models), replicating reservoir networks (e.g., for non-linear models, typically for timeseries), random forest classification, or the like.

In further implementations, QRNG security process 248 may also include, or otherwise use, one or more generative AI/ML models. In contrast to discriminative models that simply seek to perform pattern matching for purposes such as anomaly detection, classification, or the like, generative approaches instead seek to generate new content or other data (e.g., audio, video/images, text, etc.), based on an existing body of training data. For instance, in the context of machine unlearning, QRNG security process 248 may be a component of, use, and/or be utilized in the management of prompts/access to a generative model to perform layer attribution, perform layer sensitivity assessment, remove capabilities from a previously trained model, retain model performance, etc. based on a conversational input from a user (e.g., voice, text, etc.). Example generative approaches can include, but are not limited to, generative adversarial networks (GANs), large language models (LLMs) and other foundation models, diffusion models, transformer models, and the like.

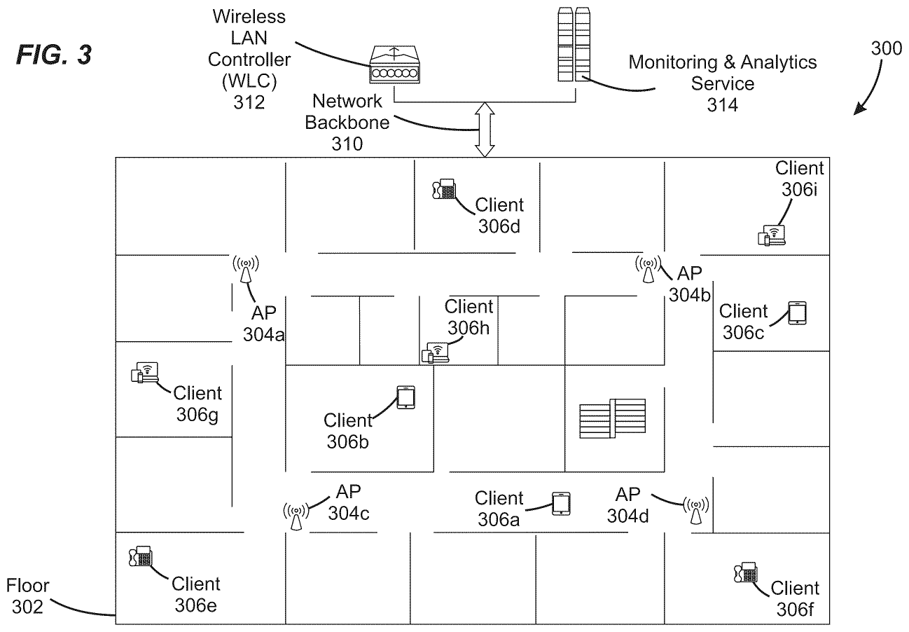

FIG. 3 illustrates an example wireless network 300, according to various embodiments. Wireless network 300 may be deployed to a physical location, such as floor 302 shown, and may include various infrastructure devices. These infrastructure devices may include, for example, one or more access points (APs 304) that provide wireless connectivity to the various wireless clients 306 distributed throughout the location. For illustrative purposes, APs 304a-304d and clients 306a-306i are depicted in FIG. 3. However, as would be appreciated, a wireless network deployment may include any number of APs and clients.

A network backbone 310 may interconnect APs 304 and provide a connection between APs 304 and any number of supervisory devices or services that provide control over APs 304. For example, as shown, a wireless LAN controller (WLC 312) may control some or all of APs 304a-304d, by setting their control parameters (e.g., max number of attached clients, channels used, wireless modes, etc.). Another supervisory service that oversees wireless network 300 may be a monitoring and analytics service 314 that measures and monitors the performance of wireless network 300 and, if so configured, may also adjust the operation of wireless network 300 based on the monitored performance (e.g., via WLC 312, etc.). Note that monitoring and analytics service 314 may be implemented directly on WLC 312 or may operate in conjunction therewith, in various implementations.

Network backbone 310 may further provide connectivity between the infrastructure of the local network and a larger network, such as the Internet, a Multiprotocol Label Switching (MPLS) network, or the like. Accordingly, WLC 312 and/or monitoring and analytics service 314 may be located on the same local network as APs 304 or, alternatively, may be located remotely, such as in a remote datacenter, in the cloud, etc. To provide such connectivity, network backbone 310 may include any number of wired connections (e.g., Ethernet, optical, etc.) and/or wireless connections (e.g., cellular, etc.), as well as any number of networking devices (e.g., routers, switches, etc.).

The types and configurations of various wireless clients 306 in wireless network 300 can vary greatly, ranging from powerful computing devices to any number of different types of nodes/devices. For example, clients 306a-306i may include, but are not limited to, desktop computers, wireless sensors, actuators, thermostats, relays, mobile phones, other mobile devices, and the like.

However, as noted above, random number generation is at the core of many computing systems ranging from security to gaming, among others. For instance, in the case of cryptography, the degree of randomness underlying a cryptographic key (i.e., entropy) dictates how difficult it would be for a malicious entity to guess that key. However, random number generators (RNGs) today also do not rely on true randomness, but instead leverage pseudo-random number generation algorithms that seek to generate numbers that mimic the properties of truly random numbers.

Recently, there has been increased interest in quantum systems and their use in quantum RNGs (QRNGs), as the physical properties of quantum systems exhibit true randomness. Using such a quantum system as a source of entropy could lead to a truly random number generator. In turn, using truly random numbers can increase the security of a system, as there is always the possibility of the pseudo-random algorithm being subverted or compromised.

Even with a source of quantum entropy, though, the trustworthiness of its resulting random numbers is still a function of the trustworthiness of its supply chain. For instance, if the pipeline that supplies the quantum entropy to the QRNG becomes compromised, the resulting random numbers will also be compromised. Presently, the ability to detect and mitigate compromised QRNGs is limited. For example, while QRNG providers may perform self-check mechanisms that verify the QRNG's health, there are no existing mechanism to assess the security of the entropy supply chain as well as the provenance of the resulting quantum random number (QRN) as a recipient of the resulting quantum random number.

### Quantum Random Number Generator Provenance and Security Analysis

The techniques herein introduce a mechanism to protect wireless to ensure the trustworthiness of a quantum random number (QRNG) system by mitigating against vulnerabilities in its supply. In some aspects, a QRNG provenance and security management system is introduced that assesses the security of an entropy supply chain, as well as the provenance of the resulting quantum random number (QRN). In various implementations, the system may also leverage a honeypot mechanism to mitigate, characterize, and/or interfere with malicious attempts to manipulate a QRNG supply chain.

Illustratively, the techniques described herein may be performed by hardware, software, and/or firmware, such as in accordance with QRNG security process 248, which may include computer executable instructions executed by the processor 220 (or independent processor of interfaces 210) to perform functions relating to the techniques described herein.

Specifically, according to various implementations, a device may determine that an operations supply chain for a quantum noise source is a compromised supply chain. The device may discontinue generation of a quantum random number utilizing the compromised supply chain. The device may initiate sourcing of trusted quantum noise from a trusted quantum noise source. The device may cause the trusted quantum noise to be utilized in the generation of a quantum random number.

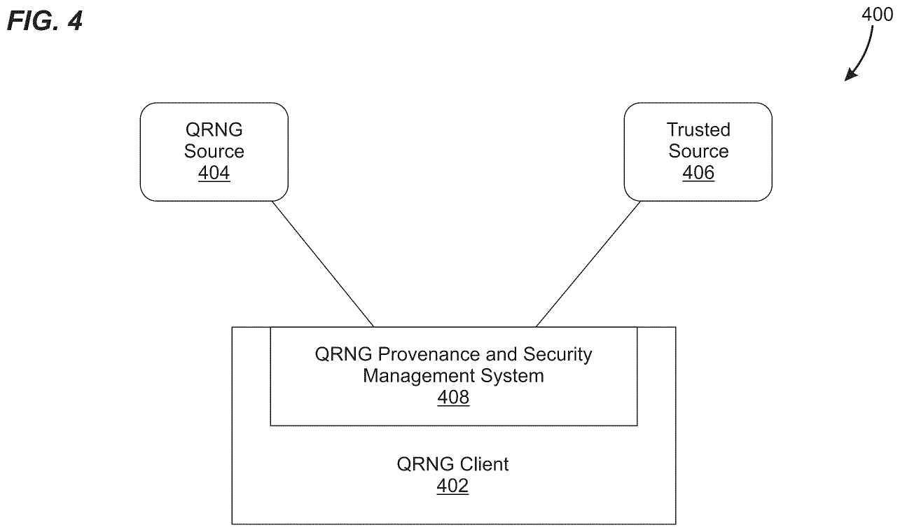

Operationally, FIG. 4 illustrates an example architecture 400 for quantum random number generator provenance and security analysis, according to various implementations. Architecture 400 may include a QRNG source 404 and a QRNG client 402 that may leverage a QRNG provenance and security management system 408 and/or a trusted source 406 for assessing and ensuring quantum random number generator provenance and security.

The QRNG source 404 may be the component of architecture 400 that operates as an external source of quantum-based random numbers. Generally, the QRNG source 404 may include the hardware and/or instructions to generate and/or provide quantum entropy outputs. The quantum energy outputs may include and/or be leveraged to produce numbers that are truly random (e.g., QRNs), as opposed to those produced by current asymmetric encryption cryptography methods which are increasingly able to be cracked with contemporary compute power.

For example, the QRNG source 404 may include a quantum entropy device that may serve as the root of randomness. The quantum entropy device may include devices that rely on quantum effects to generate randomness. For instance, the quantum entropy device may rely on quantum phenomena such as photon polarization, quantum vacuum fluctuations, radioactive decay, electronic tunneling, etc. for generating raw quantum randomness. Of course, multiple sources of quantum entropy may be utilized as well.

Additionally, or alternatively, The QRNG source 404 may include a randomness extractor. The randomness extractor may include a component to process the raw random data collected from the quantum effects and/or to remove any bias or noise. The randomness extractor may be configured to generate a QRN and/or the data that can be used to generate a QRN from the raw random data.

In addition, the QRNG source 404 may include a communication component configured to supply the quantum entropy (e.g., as QRNs, as data, etc.) to one or more client consumers of the QRNs. Despite being the best source of true randomness currently available, QRNG systems based on unpredictable physical phenomena such as quantum effects are simply not practical to include in all devices and/or environments (e.g., given the cost and size constraints of special entropy-generating hardware, etc.). As such, the QRNG source 404 may be accessible to a client using networks, servers, etc. to serve as an external source of true entropy.

In some instances, the QRNG source 404 may include one or more hardware and/or software/firmware components that leverage, are configured as, and/or support a Quantum Entropy-as-a-Service (QEaaS) architecture. In various implementations, the QRNG source 404 may operate as an on-demand, cloud-based service that generates and distributes a supply of entropy as outputs to clients that may then leverage that entropy in various operations. For example, clients may leverage the outputs of QRNG source 404 for cryptographic operations such as generating cryptographic keys. That is, the QRNG source 404 may not necessarily generate a cryptographic key itself, but rather it may provide the client with entropy outputs that can be leveraged by the client systems to generate strong cryptographic keys without any possibility of the QRNG source 404 gaining insight into the client keys.

QRNG client 402 may include any consumer and/or communicator of the outputs of the QRNG source 404. For example, the QRNG client 402 may include a device (e.g., computing device, network device, IoT device, laptop, server, smartphone, etc.), a cloud platform, a SaaS, a distributed application, an embedded computing system, a node, an endpoint, etc. In some implementations, the QRNG client 402 may be one of a group of intermediary nodes and/or endpoints for the quantum noise outputs from the QRNG source 404. For example, the QRNG client 402 may be one of the endpoints for the quantum noise outputs of QRNG source 404 that utilizes the quantum noise outputs from the QRNG source 404 to generate its own outputs. Alternatively, or additionally, the QRNG client 402 may be an intermediary within a QRNG pipeline that plays a role in delivering the quantum noise or any resultant quantum noise outputs to other QRNG nodes or endpoints in the pipeline.

The QRNG client 402 may obtain the outputs of a communicatively coupled QRNG source (e.g., QRNG source 404) for the purposes of securely generating a strong cryptographic key. Since the QRNG source 404 itself and/or the intervening components and communication media are external to and/or outside the control of the QRNG client 402, the security of the entropy supply chain and/or the provenance of the resulting QRNs may be of concern to the QRNG client 402. For example, the efficacy of the cryptographic operations of QRNG client 402 that are based on the outputs of the QRNG source 404 may be directly related to the trustworthiness of the outputs from the QRNG source 404 (e.g., that the QRNs are unpredictable and/or free from manipulation.

The QRNG client 402 may leverage a QRNG provenance and security management system 408 to assess and/or mitigate these concerns. In various implementations, the system may be fully or partially integrated with the QRNG client 402, be executable utilizing the resources of the QRNG client 402 and/or distributed resources, be logically and/or computationally separate from but accessible by the QRNG client 402, include distributed functionalities, etc. In some instances, the QRNG provenance and security management system 408 may be an intermediate system between the QRNG client 402 and/or the QRNG source 404 that monitors and/or manages the operations supply chain therebetween.

The QRNG provenance and security management system 408 may include hardware and/or instructions executable to assess the security of the entropy supply chain, as well as the provenance of the resulting quantum random number (QRN) (e.g., QRNG security process 248).

For example, the QRNG provenance and security management system 408 may be configured to detect any potential vulnerabilities and threats in the entropy supply chain. Further, the system may assess risk associated with the exploit of the vulnerabilities. Furthermore, the system may be configured to remediate the vulnerabilities and/or their exploitation.

With respect to the provenance of QRNs, the QRNG provenance and security management system 408 may determine how the current state of entropy in the generated bits is reached. Further, the system may identify the operations that are carried out on the data as well as who carried those operations out.

When the analysis of the QRNG provenance and security management system 408 indicates that the operations of the supply chain are compromised it may then follow a plan of response. For instance, the analysis of the QRNG provenance and security management system 408 may indicate that the quantum noise source (e.g., QRNG source 404) is compromised such as by being broken in to and/or being replaced as a man-in-the-middle attack. In such instances, the QRNG provenance and security management system 408 may default to stopping QRNG production and/or output at the QRNG client 402.

In various implementations, architecture 400 may include one or more of a trusted source 406 that serves as a trusted replica of QRNG source 404 and/or an alternative source of quantum entropy data. That is, the trusted source 406 may serve as a trusted repository of uncompromised data from the QRNG source 404 and/or as a distinct QRNG source that operates independently of and/or separate from the QRNG source 404. In some instances, the trusted source 406 may obtain the quantum entropy data from the QRNG source 404 via a distinct supply chain from that of the QRNG client 402 and/or may utilize a data assurance system that confirms that its data is an uncompromised version of the data from the QRNG source 404. In some instances, the trusted source 406 may be a clone of the QRNG source 404 that can serve as a fallback if data from the QRNG source 404 is compromised.

The QRNG provenance and security management system 408 and/or the QRNG client 402 may have access to the entropy data from the trusted source 406. This data may be obtained by these components by a separate supply chain from that by which the entropy data is received from the QRNG source 404. As such, when QRNG provenance and security management system 408 detects that the QRNG source 404 is compromised, it may initiate sourcing of QRNG data from the trusted source 406 instead.

In some instances, a remediation plan may be implemented by QRNG provenance and security management system 408. For example, the bits from the trusted source 406 may be XOR-ed with those from a less trusted or compromised source (e.g., QRNG source 404). This technique may be leveraged to restore randomness and/or predictability when one of the entropy sources is compromised and/or suspected of being compromised.

If QRNG provenance and security management system 408 determines that a particular device, service, source, etc. (e.g., QRNG source 404) is compromised or suspected of being compromised, it may be offboarded. For example, the QRNG provenance and security management system 408 may discontinue utilization of the QRNG source 404 if a compromise is detected and reroute QRNG operations to trusted source 406.

Remediation plans may be implemented in order to mitigate, correct, and/or bring attention to compromised sources. For example, QRNG provenance and security management system 408 and/or QRNG client 402 may inform concerned systems and/or parties (e.g., consumers, system administrators, authorized entities of the QRNG, etc.) of the compromise. Likewise, if the provenance of the entropy bits received by the QRNG client 402 from the QRNG source 404 does not validate to be authorized, then the QRNG client 402 or the QRNG provenance and security management system 408 may alert authorized entities for QRNG pipeline.

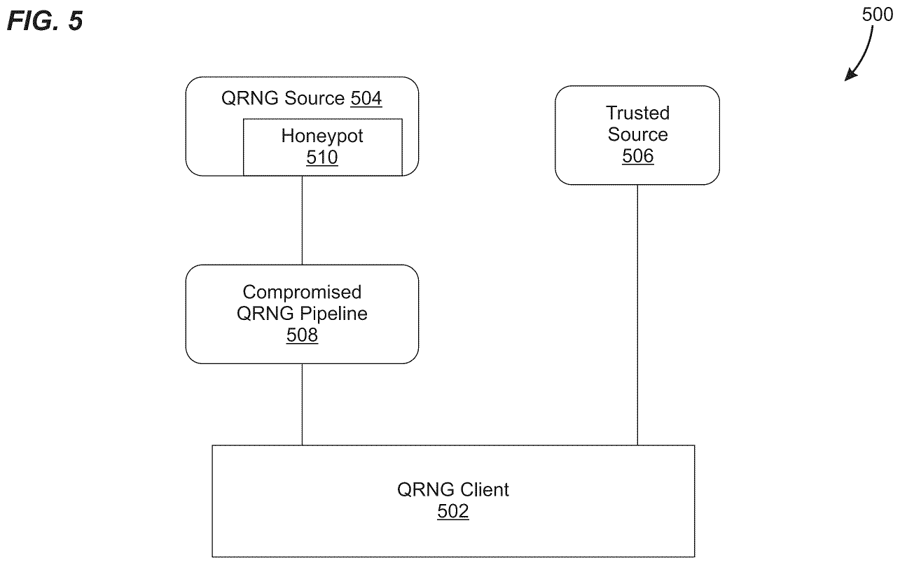

FIG. 5 illustrates an example architecture 500 utilizing a honeypot 510 to mitigate compromised QRNG pipelines, according to various implementations. Architecture 500 may include a QRNG source 504 and/or a QRNG client 502 (which may be a constituent component or endpoint of a compromised QRNG pipeline 508 and/or a recipient of quantum noise and/or any resultant quantum noise outputs from the compromised QRNG pipeline 508). The components of architecture 500 may be configured to leverage a honeypot 510 to mitigate vulnerabilities and/or observe behaviors in a compromised QRNG pipeline 508.

In various implementations, if a point and/or a sub-path of a QRNG pipeline is compromised (e.g., compromised QRNG pipeline 508) such as by an active threat, then a honeypot strategy may be implemented. This approach may be configured to not alert the active threat comprising the compromised QRNG pipeline 508.

Instead, a fake entropy generation system (e.g., honeypot 510) may be introduced. Honeypot 510 may include a quantum noise generation system that is fake. The honeypot 510 may be implemented on or in association with the QRNG source 504 and/or by devices that are on the path (e.g., the path of the compromised QRNG pipeline 508). In some instances, these components may generate fake quantum noise that may be passed down the compromised QRNG pipeline 508 as to avoid alerting any intervening downstream actors of its inauthenticity while providing legitimate or uncompromised intermediaries with an indication that the data is not authentic or not to be used.

Devices that are on the path (e.g., the path of compromised QRNG pipeline 508) may have an attack-ready mode. These devices may support a honeypot mitigation strategy by generating fake random bits and/or fake outputs without actually processing any quantum randomness data to give the impression to malicious observers that the fake data is legitimate. This may be accomplished with the same bandwidth as when processing real quantum randomness data. Meanwhile, the genuine QRNG process may be re-routed to a different phase such that a QRNG client 502 may still receive uncompromised quantum randomness data (e.g., via a different channel of the QRNG source, via a trusted source 506, etc.).

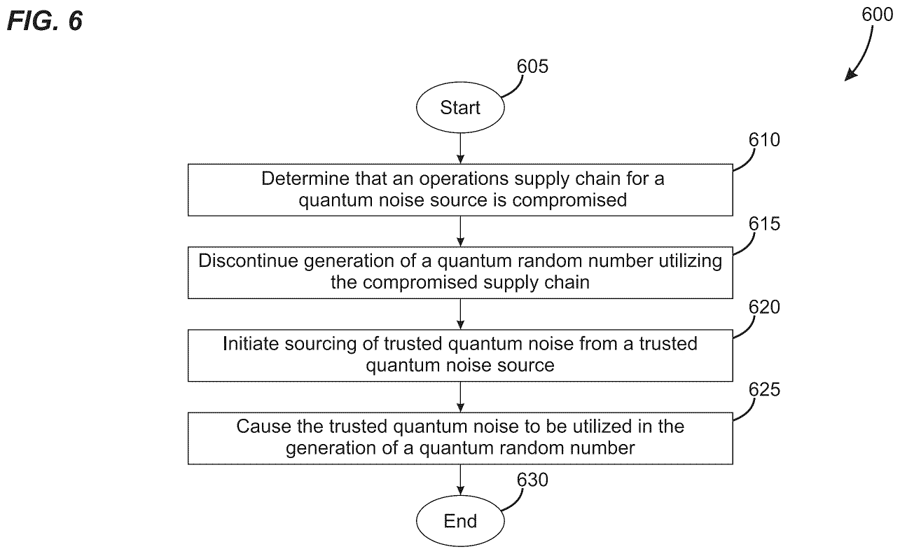

FIG. 6 illustrates an example simplified procedure (e.g., procedure 600) for quantum random number generator provenance and security analysis, according to various implementations. For example, a non-generic, specifically configured device (e.g., device 200), may perform procedure 600 (e.g., a method) by executing stored instructions (e.g., QRNG security process 248).

The procedure 600 may start at step 605, and continues to step 610, where, as described in greater detail above, the device (e.g., a controller, server, etc.) may determine whether an operations supply chain for a quantum noise source is a compromised supply chain. When a determination is may that an operations supply chain for a quantum noise source is compromised, then the authorized entities of the operations supply chain may be altered that the supply chain upon which they rely and/or participate in is compromised.

Conversely, alerting an active threat that is compromising the compromised supply chain that the compromised supply chain has been identified as being compromised may be intentionally avoided. In this manner, suspect malicious actors and/or compromised devices may be left unaware that the compromise to the supply chain has been identified. This may allow administrators to monitor, learn from, and/or manipulate the behavior of attackers without making them aware that this is occurring.

In various implementations, a honeypot threat observation and/or mitigation strategy and components may be implemented. For example, a false quantum noise source may be introduced to the compromised supply chain in order to provide false quantum noise to a component of the compromised supply chain. Additionally, or alternatively, false outputs may be generated by constituent devices of the compromised supply chain without actually processing quantum noise from the compromised supply chain. In this manner, the devices may give malicious observers the impression that the devices'outputs are legitimate and based on legitimate quantum noise.

At step 615, as detailed above, the device may discontinue or otherwise interrupt generation of a quantum random number utilizing the compromised supply chain. For example, the production and/or communication of quantum noise by the compromised supply chain be discontinued or otherwise modified so that it is no longer utilized in genuine cryptographic operations or the like that may inadvertently expose the consumers to the risk of attack or exposure of their cryptographic secrets.

At step 620, as detailed above, the device may initiate sourcing of trusted quantum noise from a trusted quantum noise source. In various implementations, the trusted quantum noise is sourced from a trusted replica of the quantum noise source. In these types of implementations, XOP operations may be performed on bits from the trusted replica of the quantum noise source and bits from the quantum noise source.

In some implementations, initiating the sourcing of the trusted quantum noise from the trusted quantum noise source can include rerouting quantum noise from the quantum noise source to a trusted replica of a compromised device in the compromised supply chain. A compromised device in the compromised supply chain can be offboarded and/or otherwise isolated or prevented from participating in a legitimate version of the supply chain.

At step 625, as detailed above, the device may cause the trusted quantum noise to be utilized in the generation of a quantum random number. In various implementations, the quantum random number may be utilized in a cryptographic security operation, such as generating a cryptographic key based on the quantum random number.

Procedure 600 may then end at step 630.

It should be noted that while certain steps within procedure 600 may be optional as described above, the steps shown in FIG. 6 are merely examples for illustration, and certain other steps may be included or excluded as desired. Further, while a particular order of the steps is shown, this ordering is merely illustrative, and any suitable arrangement of the steps may be utilized without departing from the scope of the implementations herein.

The techniques described herein, therefore, introduce a mechanism for quantum random number generator provenance and security analysis. These techniques may be leveraged to ensure the trustworthiness of a QRNG system by mitigating against vulnerabilities in its supply. By leveraging trusted quantum noise sources, cryptographic post-processing (e.g., XOR operations), and real-time integrity monitoring, these techniques may maintain a high level of entropy integrity, even when certain components of the QRNG supply become compromised.

These techniques may facilitate secure and verifiable randomness for critical applications, including cryptographic key generations, secure communications, and distributed systems, where the unpredictability of random numbers is paramount. The combination of entropy verification, redundancy, and secure randomness delivery provides reliable foundation for systems that depend on high-quality randomness data, while ensuring compliance with stringent industry standards and regulatory requirements for cryptographic entropy. This provides a concrete, practical solution for generating high-assurance randomness in scenarios where classical approaches fall short, particularly in environments where entropy integrity must be maintained despite possible supply chain risks.

In addition, the integration of a honeypot mechanism within the QRNG supply chain can be leveraged to further enhance security and performance. Such a mechanism can provide an undetectable and secure observation of attacks and attack strategies while maintaining a trusted QRNG supply chain.

While there have been shown and described illustrative implementations that provide for quantum random number generator provenance and security analysis, it is to be understood that various other adaptations and modifications may be made within the intent and scope of the implementations herein. In addition, while certain processes are shown, other suitable processes may be used, accordingly.

The foregoing description has been directed to specific implementations. It will be apparent, however, that other variations and modifications may be made to the described implementations, with the attainment of some or all of their advantages. For instance, it is expressly contemplated that the components and/or elements described herein can be implemented as software being stored on a tangible (non-transitory) computer-readable medium (e.g., disks/CDs/RAM/EEPROM/etc.) having program instructions executing on a computer, hardware, firmware, or a combination thereof. Accordingly, this description is to be taken only by way of example and not to otherwise limit the scope of the implementations herein. Therefore, it is the object of the appended claims to cover all such variations and modifications as come within the true spirit and scope of the implementations herein.

1. A method, comprising:
determining, by a device, that an operations supply chain for a quantum noise source is a compromised supply chain;
discontinuing, by the device, generation of a quantum random number utilizing the compromised supply chain;
initiating, by the device, sourcing of trusted quantum noise from a trusted quantum noise source; and
causing, by the device, the trusted quantum noise to be utilized in the generation of a quantum random number.

2. The method as in claim 1, wherein the trusted quantum noise is sourced from a trusted replica of the quantum noise source.

3. The method as in claim 2, further comprising:
performing XOR operations on bits from the trusted replica of the quantum noise source and bits from the quantum noise source.

4. The method as in claim 1, further comprising:
introducing a false quantum noise source to provide false quantum noise to a component of the compromised supply chain.

5. The method as in claim 1, further comprising:
generating false outputs without processing quantum noise from the compromised supply chain.

6. The method as in claim 1, further comprising:
alerting authorized entities of the operations supply chain that it is compromised.

7. The method as in claim 1, further comprising:
offboarding a compromised device in the compromised supply chain.

8. The method as in claim 1, wherein initiating the sourcing of the trusted quantum noise from the trusted quantum noise source includes rerouting quantum noise from the quantum noise source to a trusted replica of a compromised device in the compromised supply chain.

9. The method as in claim 1, further comprising:
avoiding alerting an active threat compromising the compromised supply chain that the compromised supply chain has been identified as compromised.

10. The method as in claim 1, further comprising:
causing the quantum random number to be utilized in a cryptographic security operation.

11. An apparatus, comprising:
one or more network interfaces;
a processor coupled to the one or more network interfaces and configured to execute one or more processes; and
a memory configured to store a process that is executable by the processor, the process when executed configured to:
determine that an operations supply chain for a quantum noise source is a compromised supply chain;
discontinue generation of a quantum random number utilizing the compromised supply chain;
initiate sourcing of trusted quantum noise from a trusted quantum noise source; and
cause the trusted quantum noise to be utilized in the generation of a quantum random number.

12. The apparatus as in claim 11, wherein the trusted quantum noise is sourced from a trusted replica of the quantum noise source.

13. The apparatus as in claim 12, wherein the process when executed is further configured to:
perform XOR operations on bits from the trusted replica of the quantum noise source and bits from the quantum noise source.

14. The apparatus as in claim 11, wherein the process when executed is further configured to:
introduce a false quantum noise source to provide false quantum noise to a component of the compromised supply chain.

15. The apparatus as in claim 11, wherein the process when executed is further configured to:
generate false outputs without processing quantum noise from the compromised supply chain.

16. The apparatus as in claim 11, wherein the process when executed is further configured to:
alert authorized entities of the operations supply chain that it is compromised.

17. The apparatus as in claim 11, wherein the process when executed is further configured to:
offboard a compromised device in the compromised supply chain.

18. The apparatus as in claim 11, wherein the sourcing of the trusted quantum noise from the trusted quantum noise source is initiated by rerouting quantum noise from the quantum noise source to a trusted replica of a compromised device in the compromised supply chain.

19. The apparatus as in claim 11, wherein the process when executed is further configured to:
avoid alerting an active threat compromising the compromised supply chain that the compromised supply chain has been identified as compromised.

20. A tangible, non-transitory, computer-readable medium storing program instructions that cause a device to execute a process comprising:
determining that an operations supply chain for a quantum noise source is a compromised supply chain;
discontinuing generation of a quantum random number utilizing the compromised supply chain;
initiating sourcing of trusted quantum noise from a trusted quantum noise source; and
causing the trusted quantum noise to be utilized in the generation of a quantum random number.
